(19) United States
(12) Patent Application Publication
(10) Pub. No.: US 2008/0210373 A1
(43) Pub. Date: Sep. 4, 2008

(54) Bonding method, bonding apparatus, and bonding jig

(75) Inventors: Michinao Nomura, Kawasaki (JP); Yoshiaki Yanagida, Kawasaki (JP); Koji Sudo, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/006,711

(22) Filed: Jan. 4, 2008

(30) Foreign Application Priority Data
Jan. 25, 2007 (JP) 2007-015474

(51) Int. Cl. C09J 5/00; B29C 65/00

(52) U.S. Cl. 156/322; 156/499; 156/536

(57) ABSTRACT

A bonding method includes a pasting process of pasting a face which is a face except the element formation surface of a rod, with a predetermined face of an adherend using a bonding material to be heat-cured, an absorption process of fixing angular relation between a direction of the adherend and a direction of the rod into predetermined angular relation by absorbing the adherend and rod on a surface of the stage on the surface of which the adherend and rod, which are pasted in the pasting process, are placed, and a heat cure process of heating and curing the bonding material in a state that the direction of the adherend and the direction of the rod are fixed to the predetermined angular relation by the absorption process.

### BACKGROUND OF THE INVENTION

1. Field of the Invention

The present invention relates to a bonding method, a bonding apparatus, and a bonding jig for bonding a rod, having an element formation surface on which two or more of elements are formed in one row, with an adherend using a bonding material which is heat-cured.

2. Description of the Related Art

In a magnetic head slider which writes and reads data to/from with magnetic media, such as a magnetic disk, a record and reproduction element is formed.

This magnetic head slider is produced by first cutting a rod which is called a bar, and on one face of which two or more of record and reproduction elements are located in one row, from a ceramic wafer in which the record and reproduction elements are formed in the surface in all directions, next adjusting so-called element height about all the elements by polishing a cut surface, the element height which determines electromagnetic characteristics of the record and reproduction elements, further giving shaping, which influences flying height from a surface of a rotating magnetic medium, to this polished cut surface, and finally separating the record and reproduction elements into each element.

Although polishing of the cut surface is performed by pressing the cut surface of this rod against a lapping plate, in order to perform this polishing with high precision, it is proposed to polish the cut surface of the rod after preparing a support by bonding this rod with an adherend which is called a tool (e.g., refer to Japanese Patent Application Publication No. 2002-50016).

### SUMMARY OF THE INVENTION

Nevertheless, in connection with high densification of magnetic disk units in recent years, enhancement in dimensional accuracy is required also about magnetic head sliders, and hence, it is necessary to manage a bonding angle of a rod to an adherend with higher precision in comparison with the past.

The present invention has been made in view of the above circumstances and provides a bonding method, a bonding apparatus, and a bonding jig for managing a bonding angle of these adherend and rod with high precision.

A bonding method of the present invention for achieving the above object is a bonding method of bonding a rod with an adherend using a bonding material which is heat-cured, the rod having an element formation surface where a plurality of elements is formed in one row, the bonding method characterized by including:

a pasting process of pasting a face of the rod off the element formation surface, with a predetermined face of the adherend using the bonding material;

an absorption process of fixing angular relation between a direction of the adherend and a direction of the rod into predetermined angular relation by placing the adherend and the rod both being pasted in the pasting process on a stage, and absorbing the adherend and the rod on a surface of the stage; and

a heat cure process of heating and curing the bonding material in a state that the direction of the adherend and the direction of the rod are fixed to the angular relation.

In the bonding method of the present invention, since a bonding material is heat-cured in a state that an adherend and a rod are absorbed on a surface of a stage in an absorption process, it is possible to fixedly bond the adherend and the rod in a state that a direction of the adherend and a direction of the rod have predetermined angular relation. Hence, according to the bonding method of the present invention, the bonding angle of these adherend and rod is manageable with high precision.

Here, it is preferable that the bonding method of the present invention has a pressurization process of applying pressure in a direction of shortening a gap between the adherend and the rod both being pasted in the pasting process, to at least either of the adherend and the rod, wherein the absorption process is a process of absorbing the adherend and the rod to which the pressure is applied in the pressurization process.

In addition, it is also a preferable aspect that the bonding method of the present invention has a rubbing process of rubbing each other both of faces, on each of which faces the adherend and the rod are pasted respectively in the pasting process, wherein the absorption process is a process of absorbing the adherend and the rod both the pasted faces of which are rubbed each other in the rubbing process.

In this way, when having the pressurization process and rubbing process, it becomes possible to prevent adhesive strength from lowering due to layer thickness of the bonding material between the adherend and rod becoming thick too much.

In addition, it is preferable that the bonding method of the present invention has a positioning process of adjusting positional relation between the adherend and the rod both being pasted in the pasting process, wherein the absorption process is a process of absorbing the adherend and the rod whose positions are adjusted in the positioning process.

When doing in this way, it is also possible to manage the positional relation between the adherend and rod in addition to the angular relation between a direction of the adherend and a direction of the rod.

In addition, it is also a preferable aspect that the bonding material used in the bonding method of the present invention is heated to a predetermined first temperature to be cured but softens at a temperature beyond a predetermined second temperature higher than the first temperature, and the heat cure process is a process of decreasing a temperature of the bonding material to the first temperature after increasing a temperature of the bonding material to the second temperature through the first temperature.

It becomes possible to release stress generated by curing due to exceeding of the first temperature by using such a bonding material, and thereby, it is possible to manage the bonding angle of these adherend and rod with further high precision.

A bonding apparatus of the present invention for achieving the above object is a bonding apparatus of bonding a rod with an adherend using a bonding material which is heat-cured, the rod having an element formation surface on which a plurality of elements is formed in one row,

wherein a face of the rod off the element formation surface is bonded with a predetermined face of the adherend with the bonding material, and

wherein the bonding apparatus includes:

a stage where the adherend and the rod both being pasted with the bonding material are placed and along a surface of the stage so that angular relation between a direction of the adherend and a direction of the rod becomes predetermined angular relation;

absorption control means of absorbing the adherend and the rod both being placed on the stage, on the surface of the stage; and

a heating section of heating and curing the bonding material in a state that the adherend and the rod are absorbed on the surface of the stage.

In the bonding apparatus of the present invention, since the bonding material is heat-cured in a state that the adherend and rod are absorbed on a surface of the stage in the absorption means, it is possible to fixedly bond the adherend and rod in a state that a direction of the adherend and a direction of the rod have predetermined angular relation. Hence, according to the bonding apparatus of the present invention, the bonding angle of these adherend and rod is manageable with high precision.

Here, it is preferable that the bonding apparatus of the present invention has a pressurization section of applying pressure in a direction of shortening a gap between the adherend and the rod both being pasted with the bonding material, to at least either of the adherend and the rod, wherein the adsorption control means absorbs the adherend and the rod to both of which the pressure is applied in the pressurization section, on the surface of the stage.

In addition, it is also preferable that the bonding apparatus of the present invention has rubbing means of rubbing each other both of faces on each of which faces the adherend and the rod are pasted respectively, wherein the adsorption control means absorbs the adherend and the rod, both of the whose faces being are pasted are rubbed in the rubbing means, on the surface of the stage.

In addition, it is preferable that the bonding apparatus of the present invention has a positioning section of adjusting positional relation between the adherend and the rod both being pasted, wherein the adsorption control means absorbs the adherend and the rod whose positions are adjusted in the positioning section, on the surface of the stage.

In addition, it is also a preferable aspect that the bonding material used in the bonding apparatus of the present invention is heated to a predetermined first temperature to be cured but softens at a temperature beyond a predetermined second temperature higher than the first temperature, and the heating section decreases a temperature of the bonding material to the first temperature after increasing a temperature of the bonding material to the second temperature through the first temperature.

A bonding jig of the present invention for achieving the above object is a bonding jig for bonding a rod with an adherend using a bonding material which is heat-cured, the rod having an element formation surface on which a plurality of elements is formed in one row,

wherein a face of the rod off the element formation surface is bonded with a predetermined face of the adherend with the bonding material,

wherein the bonding jig includes:

a stage where the adherend and the rod both being pasted with the bonding material are placed and along a surface of the stage so that angular relation between a direction of the adherend and a direction of the rod becomes predetermined angular relation, the stage including an absorption opening for absorbing the adherend and the rod both being placed on a surface of the stage.

The bonding jig of the present invention includes the stage in which the angular relation between these directions of the adherend and rod becomes predetermined angular relation by the adherend and rod following a surface thereof, and in which an absorption opening for absorbing the adherend and rod both being placed on the surface on the surface is provided. Thereby, since a bonding material is heat-cured as it is in a state that the adherend and rod are absorbed on the surface of the stage, it is possible to fixedly bond the adherend and rod as it is in a state that a direction of the adherend and a direction of the rod have predetermined angular relation. Hence, according to the bonding jig of the present invention, it is possible to contribute to highly accurate management of the bonding angle of these adherend and rod.

Here, it is preferable that the bonding jig of the present invention includes a pressurization section of applying pressure in a direction of shortening a gap between the adherend and the rod being pasted with the bonding material, to at least either of the adherend and the rod.

In addition, it is also preferable that the bonding jig of the present invention includes rubbing means of rubbing together the faces on each of which faces the adherend and the rod which are pasted respectively with the bonding material.

In addition, it is preferable that the bonding jig of the present invention includes a positioning section of adjusting positional relation between the adherend and the rod both being pasted.

According to the present invention, it is possible to provide a bonding method, a bonding apparatus, and a bonding jig for managing a bonding angle of these adherend and rod with high precision.

### BRIEF DESCRIPTION OF THE DRAWINGS

FIG. 1 is an external perspective view of a first embodiment of a bonding apparatus of the present invention;

FIG. 2 is a diagram illustrating an aspect that a tool and a bar are bonded;

FIG. 3 is an exploded perspective view of the bonding jig illustrated in FIG. 1;

FIG. 4 is a diagram illustrating a suction system for absorbing on the stage the tool and bar which are placed on the stage;

FIG. 5 is a diagram illustrating a flow of bonding of the tool and bar;

FIG. 6 is a diagram describing in further detail the flow of the bonding mentioned above;

FIG. 7 is a diagram illustrating a second embodiment of the bonding apparatus of the present invention;

FIG. 8(a) is an external perspective view of a bonding jig which constructs the bonding apparatus of the second embodiment;

FIG. 8(b) is an external perspective view of a body which constructs the bonding apparatus of the second embodiment;

FIG. 9(a) is a diagram illustrating a flow of bonding of a tool and a bar in the bonding apparatus of the second embodiment;

FIG. 9(b) is a diagram illustrating a flow of bonding of the tool and bar in the bonding apparatus of the second embodiment;

FIG. 9(c) is a diagram illustrating a flow of bonding of the tool and bar in the bonding apparatus of the second embodiment;

FIG. 9(d) is a diagram illustrating a flow of bonding of the tool and bar in the bonding apparatus of the second embodiment; and

FIG. 9(e) is a diagram illustrating a flow of bonding of the tool and bar in the bonding apparatus of the second embodiment.

### DETAILED DESCRIPTION OF THE INVENTION

Hereafter, embodiments of the present invention will be described.

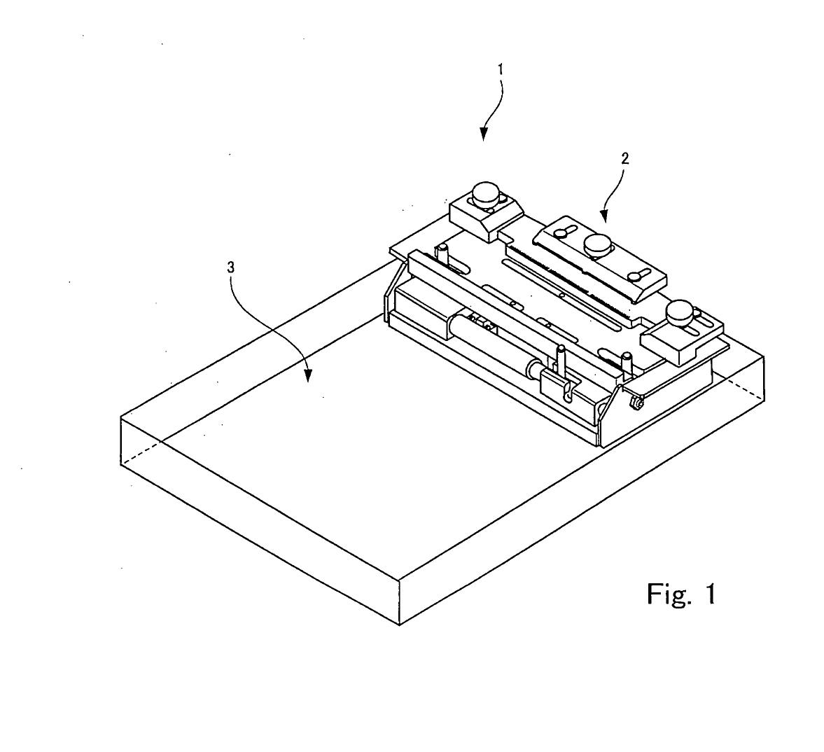

FIG. 1 is an external perspective view of a first embodiment of a bonding apparatus of the present invention.

A bonding apparatus 1 which is illustrated in FIG. 1 and which is the first embodiment is an apparatus which is constructed of a bonding jig 2 which is a first embodiment of a bonding jig of the present invention, and a heater 3 and in which one embodiment of a bonding method of the present invention is performed. This bonding apparatus 1 is an apparatus for bonding a bar, which is a rod on one face of which two or more of record and reproduction elements are located in one row, with a tool, which is an adherend to which this bar is bonded, with high precision. The heater 3 is for heating and curing a thermoplastic adhesive which is heat-cured and, which is used for bonding these tool and bar.

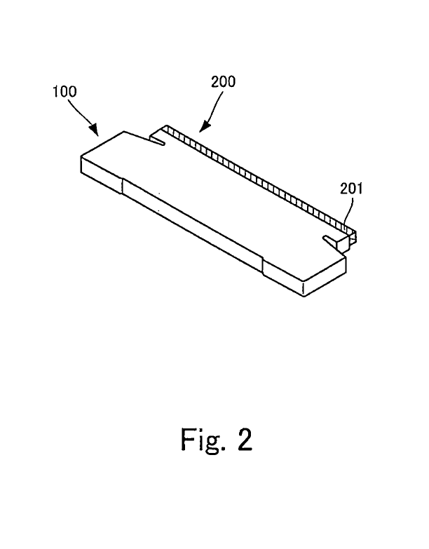

FIG. 2 is a diagram illustrating an aspect that the tool and the bar are bonded.

FIG. 2 illustrates an aspect that a bar 200 is temporarily bonded on a predetermined bonding surface of a tool 100, and the bar 200 is bonded with the tool 100 on a face adjoining an element formation surface 201 on which two or more of record and reproduction elements are formed along with one row.

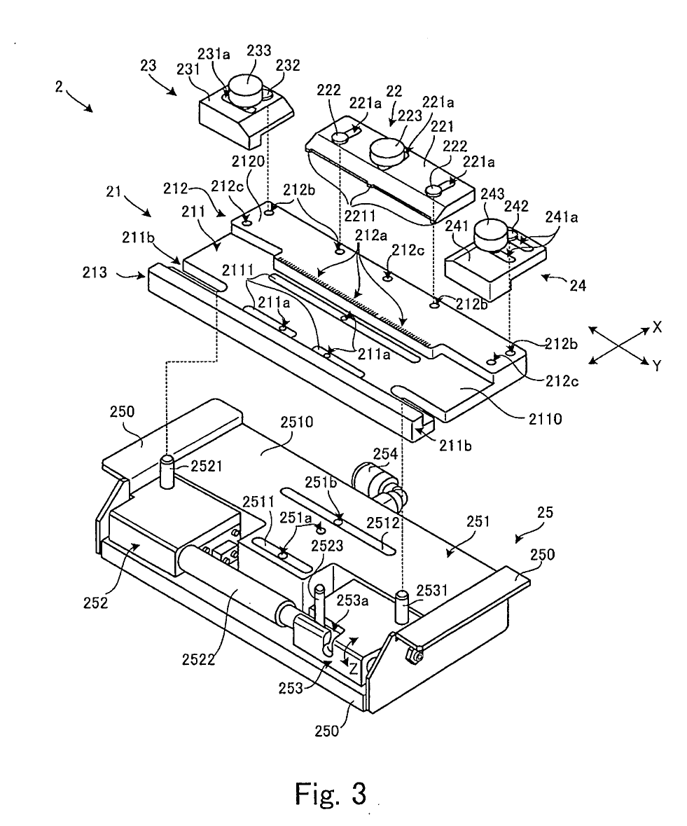

FIG. 3 is an exploded perspective view of the bonding jig illustrated in FIG. 1.

FIG. 3 illustrates an aspect that the bonding jig 2 is constructed of a stage 21, a pressurization section 22, a first positioning section 23, a second positioning section 24, and a base 25.

The stage 21 is a table on which the tool 100 and bar 200 on bonding surfaces of which the thermoplastic adhesive is coated are placed, and is constructed of a first supporting section 211 which supports the tool 100 between the tool 100 and bar 200 which are illustrated in FIG. 2, a second supporting section 212 which supports the bar 200, and a block section 213 abutting on a side face of the tool 100.

A shallow concavity 2111 is provided in a top face 2110 contacting with the tool 100 in the first supporting section 211, and a opening 211a which penetrates the first supporting section 211 is pierced in the concavity 2111. In addition, notches 211b in which clamper pins 2521 and 2531 which are installed in a standing manner on the base 25 are fit loosely are provided in the first supporting section 211.

Slits 212a are provided in a top face 2120, which contacts with the bar 200, in the second supporting section 212, and the slits 212a reach a backside of this second supporting section 212.

In addition, four first screw openings 212b for installing the pressurization section 22, the first positioning section 23, and the second positioning section 24, and three second screw openings 212c for fixing these pressurization sections 22, first positioning section 23, and second positioning section 24 to the second supporting section 212 are provided in the second supporting section 212.

The pressurization section 22 is constructed of a body 221 in which three long openings 221a are pierced, mounting screws 222 inserted into long openings 221a in both end sides, and a fixing screw 223 inserted into a central long opening 221a.

This pressurization section 22 is installed in the second supporting section 212 of the stage 21 by the two mounting screws 222 penetrating the long openings 221a in both end sides of the body 221, and screwing with the first screw openings 212b of the second supporting section 212. However, even when tips of the mounting screws 222 reach deepest sections of the first screw openings 212b, this body 221 is freely movable in an X direction illustrated in FIG. 3 without being fixed to the second supporting section 212. The fixing screw 223 is screwed with the second screw opening 212c which penetrates the center long opening 221a of the body 221, and is located in a center of the second supporting section 212. Since the body 221 is pushed against the second supporting section 212 by fastening the fixing screw 223, it is possible to fix the body 221 to a desired position on the second supporting section 212.

The first positioning section 23 is constructed of a body 231 in which two long openings 231a are pierced, a mounting screw 232 inserted into one long opening of the two long openings, and a fixing screw 233 inserted into another long opening. In addition, the second positioning section 24 is constructed of a body 241 in which two long openings 241a are pierced, a mounting screw 242 inserted into one long opening of the two long openings, and a fixing screw 243 inserted into another long opening.

The first positioning section 23 and second positioning section 24 are installed in the second supporting section 212 movably in a Y direction illustrated in FIG. 3 with the mounting screws 232 and 242 respectively, and are fixed in desired positions on the second supporting section 212 with the fixing screws 233 and 243 respectively. In addition, although lengths of the body 231 of the first positioning section 23 and body 241 of the second positioning section 24 in the X direction illustrated in FIG. 3 are illustrated in FIG. 3 to be different, this will be mentioned later.

The base 25 is constructed of a frame 250, a supporting member 251, a move section 252, a locking section 253, and a coupler 254 for connection with a vacuum pump not illustrated. While the supporting member 251 is installed in this frame 250 fixedly and supports the stage 21, shallow concavities 2511 and 2512, and the like are provided in a top face 2510.

The move section 252 is freely movable to some extent in a Y direction in FIG. 3 on the frame 250 where the first damper pin 2521 loosely fit in the notch 211b provided in the first supporting section 211 of the stage 21 is installed in a standing manner, and a shaft 2522 projects in the Y direction in FIG. 3.

The locking section 253 is freely movable to some extent in the Y direction in FIG. 3 on the frame 250 on which the second damper pin 2531 loosely fit in the notch 211b provided in an opposite side of the notch 211b of the first supporting section 211 where the first damper pin 2521 is loosely fit is installed in a standing manner, and which engages with a lever 2523 which is provided in a tip portion of the shaft 2522.

The concavity 2511 and an opening 251a in the top face 2510 of the supporting member 251 which are provided in a shaft 2522 side are provided with corresponding to the concavity 2111 and the opening 211a which are provided in the first supporting section 211 of the stage 21, and the concavity 2512 and an opening 251b in a top face 2510 of the supporting member 251 which are provided in the coupler 254 side are provided with corresponding to a slit 212a provided in the second supporting section 212 of the stage 21.

The openings 251a and 251b provided in the supporting member 251 are connected to the coupler 254 inside the supporting member 251, respectively. For this reason, when this coupler 254 is connected to a vacuum pump and air is sucked, the tool 100 and bar 200 which are placed on the stage 21 are absorbed on the top face 2110 of the first supporting section 211 of the stage 21, and the top face 2120 of the second supporting section 212.

In addition, by moving the lever 2523 in a Z direction after moving it in the Y direction illustrated in FIG. 3 along a gate 253a provided in the locking section 253 so as to narrow a gap between the first damper pin 2521 and the second damper pins 2531, a gap between the move section 252 and the locking section 253 is fixed.

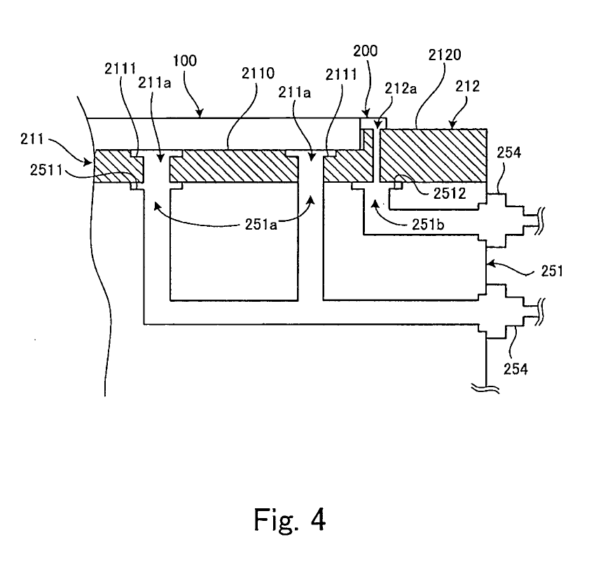

FIG. 4 is a diagram illustrating a suction system for absorbing the tool and bar which are placed on the stage.

FIG. 4 illustrates an aspect that the tool 100 is absorbed on the top face 2110 of the first supporting section 211 by the suction system which is constructed of the concavity 2111 and opening 211a which are provided in the first supporting section 211 of the stage 21, and the concavity 2511 and opening 251a which are provided in the supporting member 251.

In addition, FIG. 4 illustrates an aspect that the bar 200 is absorbed on the top face 2120 of the second supporting section 212 by the suction system which is constructed of the slit 212a provided in the second supporting section 212 of the stage 21, and the concavity 2512 and opening 251b which are provided in the supporting member 251.

Hereafter, bonding of the tool 100 and bar 200 in this bonding apparatus 1 will be described.

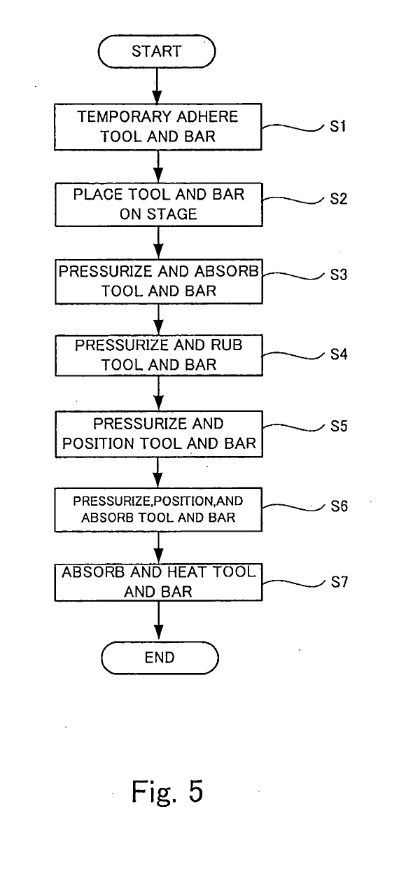

FIG. 5 is a diagram illustrating a flow of bonding of a tool and a bar.

At step S1 illustrated in FIG. 5, temporary bonding is performed by pasting the tool 100 and bar 200 using a thermoplastic adhesive. At step S2, these tool 100 and bar 200 which are temporarily bonded are placed on the stage 21 illustrated in FIG. 3. At step S3, while pressure by the pressurization section 22 in a direction of shortening a gap between these tool 100 and bar 200 is given, the tool 100 and bar 200 are absorbed on the stage 21. At step S4, although absorption is once stopped, the tool 100 is rubbed to the bar 200 with applying the pressure by the pressurization section 22. At step S5, the bar 200 is positioned to the tool 100 by the first positioning section 23 and second positioning section 24 with applying the pressure by the pressurization section 22. The absorption is resumed at step S6. At step S7, although the pressurization by the pressurization section 22 and positioning by the first positioning section 23 and second positioning section 24 are released, the heater 3 heats the bonding jig 2 with performing the absorption.

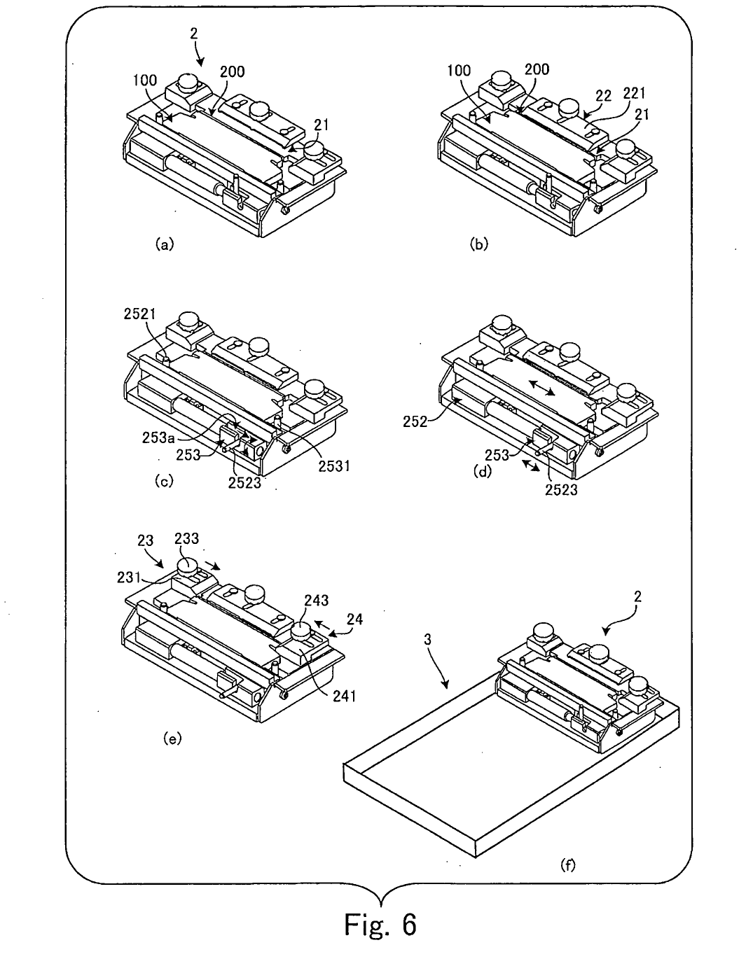

FIG. 6 is a diagram describing in further detail the flow of the bonding mentioned above.

Part (a) of FIG. 6 illustrates an aspect that the tool 100 and bar 200 which are temporarily bonded with being pasted with an adhesive as illustrated in FIG. 2 are placed on the stage 21 of the bonding jig 2. Part (b) of FIG. 6 illustrates an aspect that the body 221 of the pressurization section 22 abuts on the bar 200 placed on the stage 21 to be pressurized. Here, suction by a vacuum pump is performed simultaneously and it is confirmed with a pressure sensor not illustrated that vacuum pressure becomes a specified value or higher. Part (c) of FIG. 6 illustrates an aspect that the first damper pin 2521 and the second damper pin 2531 sandwich the tool 100 by moving the lever 2523 along a gate 253a provided in the locking section 253 as shown by an arrow. Here, although the pressure from the pressurization section 22 is applied, suction by a vacuum pump is stopped only to the tool 100. Part (d) of FIG. 6 illustrates an aspect of holding the lever 2523 with sandwiching the tool 100 between the first damper pin 2521 and second damper pin 2531, making them reciprocate with the move section 252 and locking section 253 in a direction illustrated by an arrow in Part (d) of FIG. 6, and sliding the tool 100 to the bar 200 in connection with this. Here, the pressure from the pressurization section 22 is still applied. Thus, it is for preventing a drop of the adhesive strength by adhesive thickness becoming thick too much to perform pressurization so as to narrow the gap between the bar 200 and tool 100, and to slide the tool 100 to the bar 200, in this way. Part (e) of FIG. 6 illustrates an aspect of holding the lever 2523 and moving the move section 252 and locking section 253 therewith toward the second positioning section 24 to make edge faces of the tool 100 and bar 200 abut on the body 241 of the second positioning section 24 after moving the body 241 of the second positioning section 24 to a predetermined position on the second supporting section 212, which is determined beforehand, and fixing them with the fixing screw 243, and further fixing the body 231 of the first positioning section 23 with the fixing screw 233 with pushing them toward the second positioning section 24. As mentioned above, although the body 241 of the second positioning section 24 is longer in the X direction illustrated in FIG. 3 than the body 231 of the first positioning section 23, and having a dimension of coming to a part of a side face of the tool 100, the body 231 of the first positioning section 23 has a dimension of only coming to a side face of the bar 200. For this reason, it is possible to position the bar 200 to the tool 100 with high precision only by pushing the body 231 of the first positioning section 23 toward the second positioning section 24. The suction by the vacuum pump is resumed after positioning of the bar 200 to the tool 100. Part (f) of FIG. 6 illustrates an aspect that the heater 3 heats the bonding jig 2 in a state that the pressurizing operation by the pressurization section 22, first positioning section 23, and second positioning section 24 is released. In addition, the release of these pressurizing operations is performed after it is confirmed with a pressure sensor that vacuum pressure becomes a specified value or higher, and the suction by the vacuum pump is continued during the heating.

The thermoplastic adhesive used for the bonding of the tool 100 and bar 200 has a characteristic to soften at a temperature equal to or more than a predetermined second temperature which is higher than a predetermined first temperature although being cured by being heated to this first temperature here, and hence, heating by the heater 3 illustrated in Part (f) of FIG. 6 is performed with following the following three steps.

First, the bonding jig 2 is heated by the heater 3, and a temperature of the adhesive is raised to the first temperature for the adhesive to be temporarily cured. Then, through natural-cooling, the temperature of the adhesive is raised to the second temperature higher than the first temperature for the adhesive to be made to once soften, and is naturally cooled again, and thereby, the adhesive is made to reach real cure. A reason why the adhesive which is temporary cured is once softened in this way is for releasing stress generated on the occasion of temporary cure to reduce stress, which remains inside the adhesive after the real cure, as much as possible.

As described above, since the bonding apparatus 1 of this embodiment heat-cures an adhesive in a state of absorbing the tool 100 and bar 200 on a surface of the stage 21 by the suction of a vacuum pump, it is possible to fixedly bond these tool 100 and bar 200 in a state that a direction of the tool 100 and a direction of the bar 200 have predetermined angular relation. Hence, according to the bonding apparatus 1 of this embodiment, the bonding angle of these tool 100 and bar 200 is manageable with high precision.

Next, a second embodiment of a bonding apparatus of the present invention will be described.

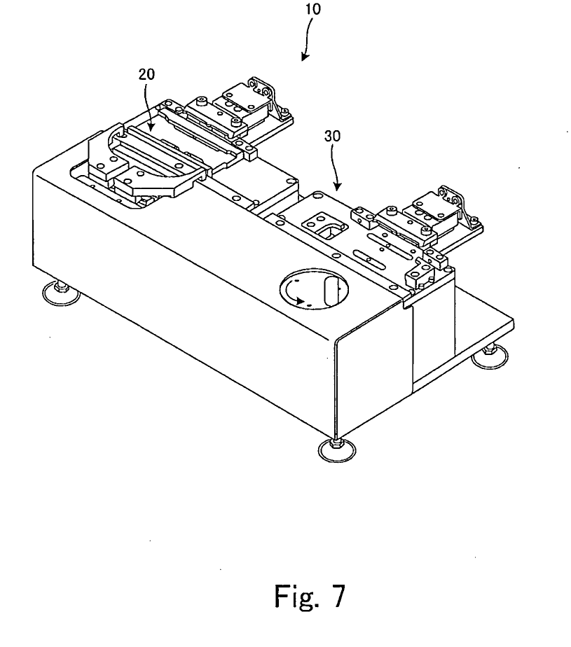

FIG. 7 is a diagram illustrating a second embodiment of the bonding apparatus of the present invention.

A bonding apparatus 10 which is the second embodiment is an apparatus which is constructed of a bonding jig 20 which is a second embodiment of a bonding jig of the present invention, and a body 30, and in which the same bonding method as the bonding method in the bonding apparatus 1 which is the first embodiment is performed.

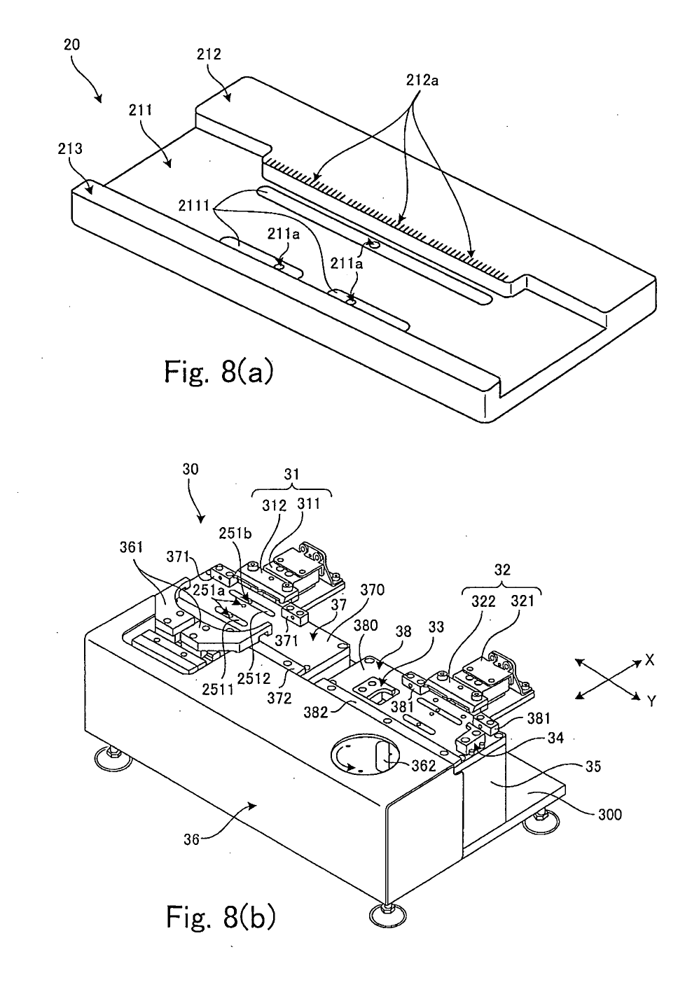

FIGS. 8(a) and 8(b) includes external perspective views of a bonding jig and a body, which construct the bonding apparatus of the second embodiment, respectively.

FIG. 8(a) illustrates the bonding jig 20 of the bonding apparatus 10 of the second embodiment, and FIG. 8(b) illustrates the body 30 of the bonding apparatus 10. In addition, the same reference numerals as the reference numerals assigned in FIG. 3 are assigned to the same kinds of members as members provided in the stage 21, illustrated in FIG. 3, among members provided in the bonding jig 20 illustrated in FIG. 8(a). In addition, the same reference numerals as the reference numerals assigned in FIG. 3 are assigned to the same kinds of members as members provided in the supporting member 251, illustrated in FIG. 3, among members provided in the body 30 illustrated in FIG. 8(b).

The bonding jig 20 illustrated in FIG. 8(a) has the almost same shape and the same functions as the stage 21 of the bonding jig 2 of the bonding apparatus 1 which is the first embodiment. In addition, the bonding method of the tool 100 and bar 200 in the bonding apparatus 10 of the second embodiment is the same as the bonding method in the bonding apparatus 1 which is the first embodiment. Hence, descriptions about these are omitted, and hereafter, the body 30 illustrated in FIG. 8(b) will be described in detail.

The body 30 illustrated in FIG. 8(b) is constructed of a frame 300, a first pressurization section 31, a second pressurization section 32, a first positioning section 33, a second positioning section 34, a heater section 35, a slide section 36, a first plate section 37, and a second plate section 38.

The first plate section 37 is constructed of a plate face 370, and a first guide 371 and a second guide 372 which guide the bonding jig 20 illustrated in FIG. 8(a). In addition, the second plate section 38 is constructed of a plate face 380, and a first guide 381 and a second guide 382 which guide the bonding jig 20 illustrated in FIG. 8(a). Furthermore, in the respective plate faces 370 and 380, concavities and openings which have the same functions as those of the concavity 2511 and opening 251a, which are provided in a shaft side, in the top face 2510 of the supporting member 251 of the base 25 illustrated in FIG. 3, the concavity 2512 and opening 251b which are provided in a coupler 254 side are provided. Moreover, in the respective first plate section 37 and second plate section 38(a)ir couplers for connection with vacuum pump not illustrated are installed, and also suction systems for absorbing the tool 100 and bar 200 which are placed in this bonding jig 20 on a surface of the bonding jig 20 are formed inside the first plate section 37 and second plate section 38.

The first pressurization section 31 and second pressurization section 32 are constructed of air cylinders 311 and 321, and pressurizing plates 312 and 322 connected to these air cylinders 311 and 321. The air cylinders 311 and 321 are freely movable in the X direction illustrated in FIG. 8(b), and in connection with this, the pressurizing plates 312 and 322 are also freely movable in the X direction. The air cylinders 311 and 321 advance toward the first plate section 37 and second plate section 38 respectively when air is sent in, and they separate from the first plate section 37 and second plate section 38 gradually when the sending of air is stopped. In addition, the first pressurization section 37 and second pressurization section 38(a)re installed in the first plate section 37 and second plate section 38, respectively.

The slide section 36 is constructed of a sliding arm 361 which sandwiches the tool 100 out of the tool 100 and bar 200 which are placed on the bonding jig 20 illustrated in FIG. 8(a) and are in the state illustrated in FIG. 2, from side to side, and a lever 362 operated at the time of driving this sliding arm 361. While being freely movable to some extent in the X direction illustrated in FIG. 8(b), the sliding arm 361 swings in the Y direction illustrated in FIG. 8(b) by turning this lever 362 so as to draw a circle. The swinging of the sliding arm 361 which sandwiches the tool 100 prevents a drop of adhesive strength caused by thickness of the adhesive applied between the bar 200 and tool 100 becoming thick too much.

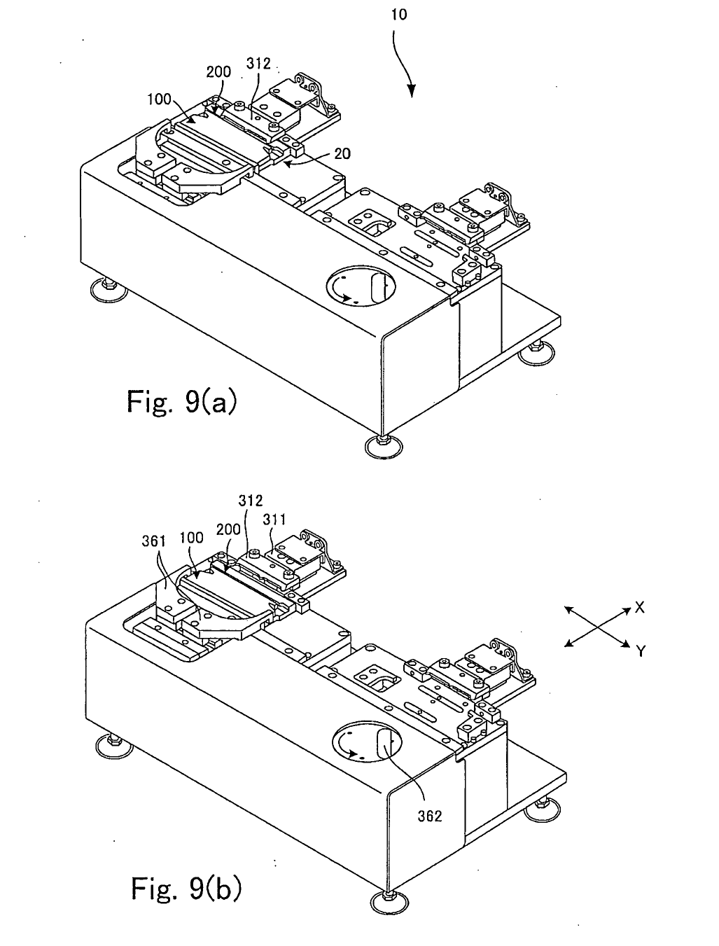

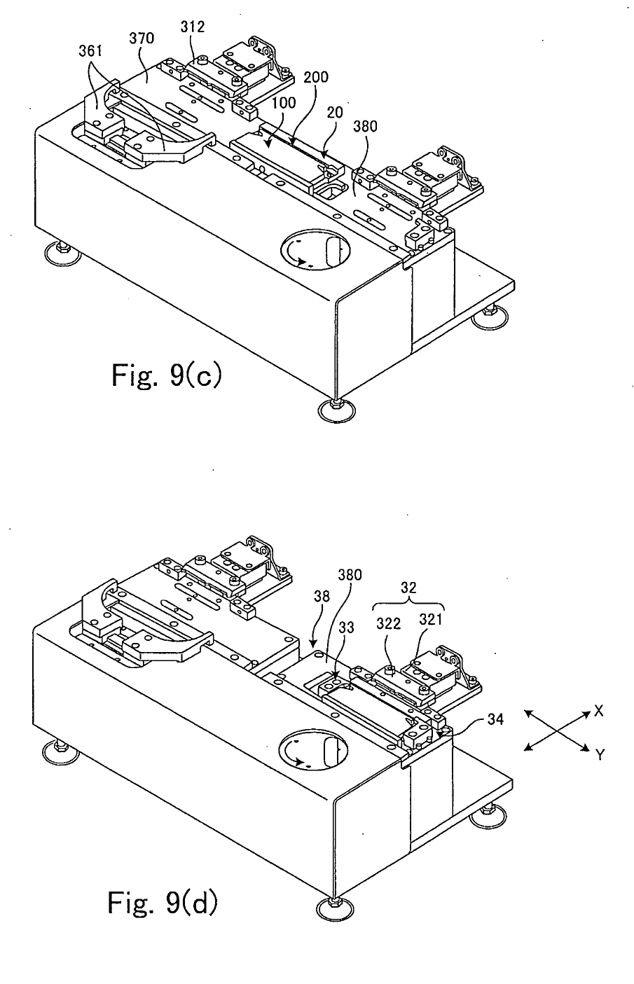

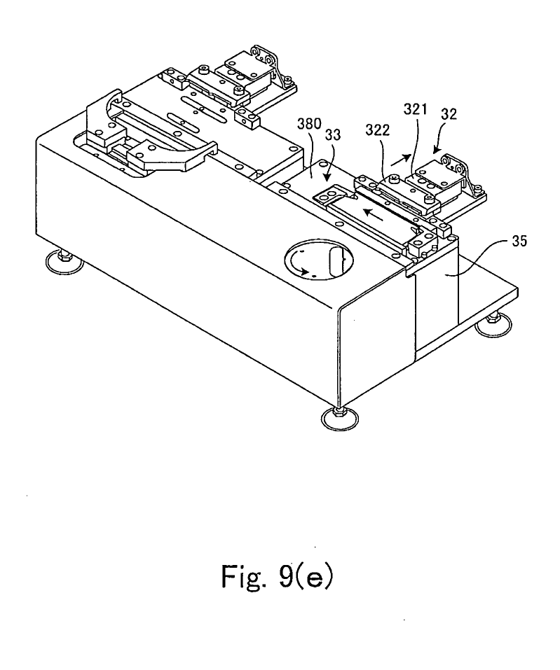

While freely rising and falling between a state of being buried rather than the plate face 380 of the second plate section 38, and a state (refer to FIG. 9(d) of projecting from this plate face 380, the first positioning section 33 is freely movable to some extent also in the Y direction illustrated in FIG. 8(b) in a state of projecting from the plate face 380.

The second positioning section 34 is arranged fixedly in a state of projecting from a top face of the plate face 380 of the second plate section 38.

The heater section 35 is arranged in a position of supporting the second plate section 38.

Hereafter, bonding of the tool 100 and bar 200 in this bonding apparatus 10 will be described.

FIGS. 9(a) to 9(e) include diagrams illustrating a flow of bonding of a tool and a bar in the bonding apparatus of the second embodiment.

FIG. 9(a) illustrates an aspect that the tool 100 and bar 200 which are temporarily bonded by a thermoplastic adhesive being applied are placed on the bonding jig 20 of the bonding apparatus 10 illustrated in FIG. 7. In addition, FIG. 9(a) illustrates an aspect that air is sent into the air cylinder 311 and the pressurizing plate 312 is made to abut on the bar 200 so as to push the bar 200 against the tool 100. Here, suction by a vacuum pump is also performed, and pressurization by the pressurizing plate 312 is performed with absorbing the tool 100 and bar 200 on the surface of the bonding jig 20.

FIG. 9(b) illustrates an aspect that the tool 100 is sandwiched by the sliding arm 361 out of the tool 100 and bar 200 which are placed on the bonding jig 20. Here, the bonding apparatus 10 once stops the suction by the vacuum pump to the tool 100, rotates the sliding lever 362 in an arrow direction illustrated in FIG. 9(b), and swings the sliding arm 361 in the Y direction illustrated in FIG. 9(b). Thereby, since the tool 100 is slid to the bar 200, the adhesive applied between these is extended suitably. Then, the suction by the vacuum pump to the bar 200 is also stopped.

FIG. 9(c) illustrates an aspect that the bonding jig 20 on which the tool 100 and bar 200 are placed is moving to the second plate section 38 from the first plate section 37 after release of the pressurization by the pressurizing plate 312 and evacuation of the sliding arm 361 are performed. In addition, FIG. 9(c) illustrates an aspect that the first positioning section 33 descends downward rather than the plate face 380 so as not to prevent movement of the bonding jig 20 to the second plate section 38 from the first plate section 37.

FIG. 9(d) illustrates an aspect that the bonding jig 20 reaches the plate face 380 of the second plate section 38, and the projection from the plate face 380 of the first positioning section 33 is being completed. Here, air is further sent into the air cylinder 321 of the second pressurization section 32, the first positioning section 33 moves toward the second positioning section 34 in a state that the pressurizing plate 322 presses the bar 200 on the bonding jig 20 toward the tool 100 in connection with this, and positioning of the bar 200 to the tool 100 is performed. Then, the suction by the vacuum pump is resumed to the both parties of the tool 100 and bar 200.

FIG. 9(e) illustrates an aspect that evacuation of the pressurizing plate 322 of the second pressurization section 32, and evacuation and fall of the first positioning section 33 from the plate face 380 are performed. Here, the bonding jig 20 is heated by the heater section 35 in a state that the suction by the vacuum pump is performed. Thereby, the adhesive is cured with keeping the angular relation in predetermined angular relation between directions of the tool 100 and bar 200. In addition, since being the same method as the heating method described in the first embodiment, a description of the heating method by the heater 35 will be omitted.

As described above, since the bonding apparatus 10 of this embodiment heat-cures an adhesive in a state of absorbing the tool 100 and bar 200 on a surface of the bonding jig 20 by the suction of a vacuum pump, it is possible to fixedly bond these tool 100 and bar 200 in a state that a direction of the tool 100 and a direction of the bar 200 have predetermined angular relation. Hence, according to the bonding apparatus 10 of this embodiment, the bonding angle of these tool 100 and bar 200 is manageable with high precision.

In addition, although the case that the suction by a vacuum pump is also performed simultaneously at the time of pushing the bar 200 to the tool 100 is cited as the example and is described in the first embodiment and second embodiment which are described above, it is not necessary in the present invention to perform sucking at the time of pushing the bar 200 to the tool 100 so long as the tool 100 and bar 200 are sucked on the surface of the stage 21 or bonding jig 20 at the time of the cure of the adhesive setting by heating. In addition, although the case of making the bar 200 rub the tool 100 and the case of positioning the bar to the tool 100 while pressing the bar 200 to the tool 100 are cited as the examples and are described in the first embodiment and second embodiment which are described above, even if the rubbing and positioning are not performed simultaneously with the pressure, or even if all of these are not perform, a fundamental effect of the present invention is not decreased.

What is claimed is:

1. A bonding method of bonding a rod with an adherend using a bonding material which is heat-cured, the rod having an element formation surface where a plurality of elements is formed in one row, comprising:
a pasting process of pasting a face of the rod off the element formation surface, with a predetermined face of the adherend using the bonding material;
an absorption process of fixing angular relation between a direction of the adherend and a direction of the rod into predetermined angular relation by placing the adherend and the rod both being pasted in the pasting process on a stage, and absorbing the adherend and the rod on a surface of the stage; and
a heat cure process of heating and curing the bonding material in a state that the direction of the adherend and the direction of the rod are fixed to the angular relation.

2. The bonding method according to claim 1, further comprising a pressurization process of applying pressure in a direction of shortening a gap between the adherend and the rod both being pasted in the pasting process, to at least either of the adherend and the rod, wherein the absorption process is a process of absorbing the adherend and the rod to which the pressure is applied in the pressurization process.

3. The bonding method according to claim 1, further comprising a rubbing process of rubbing each other both of faces, on each of which faces the adherend and the rod are pasted respectively in the pasting process, wherein the absorption process is a process of absorbing the adherend and the rod both the pasted faces of which are rubbed each other in the rubbing process.

4. The bonding method according to claim 1, further comprising a positioning process of adjusting positional relation between the adherend and the rod both being pasted in the pasting process, wherein the absorption process is a process of absorbing the adherend and the rod whose positions are adjusted in the positioning process.

5. The bonding method according to claim 1, wherein the bonding material is heated to a predetermined first temperature to be cured but softens at a temperature beyond a predetermined second temperature higher than the first temperature, and the heat cure process is a process of decreasing a temperature of the bonding material to the first temperature after increasing a temperature of the bonding material to the second temperature through the first temperature.

6. A bonding apparatus of bonding a rod with an adherend using a bonding material which is heat-cured, the rod having an element formation surface on which a plurality of elements is formed in one row,
wherein a face of the rod off the element formation surface is bonded with a predetermined face of the adherend with the bonding material, and
wherein the bonding apparatus further comprises:
a stage where the adherend and the rod both being pasted with the bonding material are placed and along a surface of the stage so that angular relation between a direction of the adherend and a direction of the rod becomes predetermined angular relation;
absorption control means of absorbing the adherend and the rod both being placed on the stage, on the surface of the stage; and
a heating section of heating and curing the bonding material in a state that the adherend and the rod are absorbed on the surface of the stage.

7. The bonding apparatus according to claim 6, further comprising a pressurization section of applying pressure in a direction of shortening a gap between the adherend and the rod both being pasted with the bonding material, to at least either of the adherend and the rod, wherein the adsorption control means absorbs the adherend and the rod to both of which the pressure is applied in the pressurization section, on the surface of the stage.

8. The bonding apparatus according to claim 6, further comprising rubbing means of rubbing each other both of faces on each of which faces the adherend and the rod are pasted respectively, wherein the adsorption control means absorbs the adherend and the rod, both of the whose faces being are pasted are rubbed in the rubbing means, on the surface of the stage.

9. The bonding apparatus according to claim 6, further comprising a positioning section of adjusting positional relation between the adherend and the rod both being pasted, wherein the adsorption control means absorbs the adherend and the rod whose positions are adjusted in the positioning section, on the surface of the stage.

10. The bonding apparatus according to claim 6, wherein the bonding material is heated to a predetermined first temperature to be cured but softens at a temperature beyond a predetermined second temperature higher than the first temperature, and the heating section decreases a temperature of the bonding material to the first temperature after increasing a temperature of the bonding material to the second temperature through the first temperature.

11. A bonding jig for bonding a rod with an adherend using a bonding material which is heat-cured, the rod having an element formation surface on which a plurality of elements is formed in one row,
wherein a face of the rod off the element formation surface is bonded with a predetermined face of the adherend with the bonding material, and
wherein the bonding jig further comprises:
a stage where the adherend and the rod both being pasted with the bonding material are placed and along a surface of the stage so that angular relation between a direction of the adherend and a direction of the rod becomes predetermined angular relation, the stage including an absorption opening for absorbing the adherend and the rod both being placed on a surface of the stage.

12. The bonding jig according to claim 11, further comprising a pressurization section of applying pressure in a direction of shortening a gap between the adherend and the rod being pasted with the bonding material, to at least either of the adherend and the rod.

13. The bonding jig according to claim 11, further comprising rubbing means of rubbing together the faces on each of which faces the adherend and the rod which are pasted respectively with the bonding material.

14. The bonding jig according to claim 11, further comprising a positioning section of adjusting positional relation between the adherend and the rod both being pasted.
